(19) United States
(12) Patent Application Publication
(10) Pub. No.: US 2009/0125587 A1
(43) Pub. Date: May 14, 2009

(54) Management System, Device for Use in the System, Program Therefor, and Management Method

(75) Inventors: Teruyuki Baba, Tokyo (JP); Tetsuo Imai, Tokyo (JP)

Correspondence Address: FOLEY AND LARDNER LLP;SUITE 500, 3000 K STREET NW, WASHINGTON, DC, 20007, US

(73) Assignee: NEC CORPORATION, Tokyo (JP)

(21) Appl. No.: 11/791,672

(22) PCT Filed: Nov. 25, 2005
(86) PCT No.: PCT/JP05/21708

§ 371 Date: May 25, 2007

(30) Foreign Application Priority Data
Nov. 26, 2004 (JP) 2004-343175

(51) Int. Cl. G06F 15/16

(52) U.S. Cl. 709/204

(57) ABSTRACT

Assignment function notifying means (24) of a shelf management unit (2) notifies assignment function accepting means (35) of a board management unit (3a), what function executing right is assigned. Subsequently, execution function selecting means (34) of the board management unit (3a) selects a function to be actually executed, from the functions which can be executed in the board. After the shelf management unit (2) notified the function be assigned, the information be used in the function to be assigned is notified from using information notifying means (26) to using information accepting means (37) of a second device. After this, function executing means (38) of the board management unit (3a) executes the function assigned.

### APPLICABLE FIELD IN THE INDUSTRY

The present invention relates to a management system, a device for using this system, a program therefore, and a management method, and more particularly to a management system that enables dynamic load distribution between devices, a device for using this system, a program therefore, and a management method.

### BACKGROUND ART

There exists a centralized management system shown in FIG. 11 as a conventional management system. The centralized management system shown in FIG. 11 is a management system in which a shelf management unit 200 centralizedly manages all boards 500a to 500d within a shelf 400.

Hereinafter, a specific operation of the centralized management system will be explained by exemplifying the case of managing a failure recovery function. Additionally, the failure recovery function in this explanation is realized by a survival confirmation for detecting abnormality in each board and a redundancy switchover for switching an active board over to a stand-by board in having detected abnormality.

In centralized management system, the survival confirmation and the redundancy switchover are executed in the shelf management unit 200, and each of board management units 300a to 300d responds hereto. The survival confirmation is realized by using a polling between the shelf management unit 200 and each of the board management units 300a to 300d. The polling is for making the survival confirmation of an object of management by transmitting a response request message from the management unit for centralizedly managing an object of management to the object of management, and receiving a response from the object of management.

The board 300a responds to the response request message from the shelf management unit 200, thereby enabling the shelf management unit 200 to confirm that the board 300a survives. The shelf management unit 200 similarly transmits the response request message to the boards 300b to 300d as well, and receives the response, thereby enabling the survival thereof to be confirmed. If no response is given from the board 300a, the shelf management unit 200 recognizes that a failure has occurred in the board 300a, and executes the redundancy switchover.

Upon detecting a failure in the board 300a by means of the survival confirmation, the shelf management unit 200 shifts a process allotted to the board 300a to the board 300b, being a stand-by board, by means of the switchover, thereby allowing the redundancy switchover in the centralized management system to be realized. The shelf management unit 200 centralizedly manages a combination of the active board, which should be switched over at the time of the failure, and the stand-by board, and each of the board management units 300a to 300d has not the stand-by board for each board stored.

Such a centralized management system makes it possible to alleviate the process that is performed in the board management units 300a to 300d because the shelf management unit 200 executes each function. Further, the shelf management unit 200, which can collectively manage survival information associated with all boards within the shelf, can optimize and set a combination of the active board and the stand-by board from a viewpoint of information of the entirety of the shelf. However, when the number of the board that is managed by the shelf management unit 200 is increased, the load of the shelf management unit 200 augments, which restricts the number of the manageable board.

So as to solve this problem, the distributed management system has been proposed in which no shelf management unit for collectively managing the boards exists, and each board management unit manages each board cooperatively (for example, Patent document 1).

In the distributed management system shown in FIG. 12, each of boards 800a to 800d distributedly executes the function executed by the shelf management unit 200 of a shelf 600. For example, with the survival conformation, a heartbeat message is exchanged between the boards. This heartbeat message is a message that is transmitted every constant time in order to notify a transmission destination that a transmission source is operating normally. This heartbeat message enables the object of management to notify its survival without receiving the request message.

For example, by exchanging the heartbeat message between a board management unit 700a and a board management unit 700c, the survival of respective boards is confirmed. If the heartbeat message from the board management unit 700a comes to a halt, the board management unit 700c can detect a failure of the board 800a. When the failure is detected, mediation among the boards 800b to 800d, each of which is a normal board, is made as to which board executes the process as a stand-by one of the board 800a. When the board 800b is selected as a stand-by one as a result of the mediation, the function executed by the board 800a is shifted to the board 800b by means of the switchover.

In such a manner, the distributed management system makes it possible to distribute the load at the time of executing the survival confirmation function, which has concentrated upon the shelf management unit 200 in the centralized management system, to each board, and to increase the number of the board that becomes an object of management.

Further, the function distributing system allowing a central device side (for example, the shelf management unit) and a terminal side (the board) to take the partial charge of a processing function by integrating the centralized management system and the distributed management system has been proposed (for example, Patent document 2). This system is a system for, when a failure occurs in the central device side, assigning one part of its processing function to the terminal side.

Patent document 1: JP-P1996-314875A

Patent document 2: JP-P1995-287728A

### DISCLOSURE OF THE INVENTION

### Problems to be Solved by the Invention

There exist the following problems in the centralized management system and the distributed management system each of which is the foregoing prior art.

The first point at issue is that the conventional centralized management system and distributed management system cannot cope with a change in a dynamic load. The reason is that it is pre-decided at the time of designing the device whether to execute the management of the device by means of the centralized management system or by means of the distributed management system.

For example, in a case of using the centralized management system, when the number of the board that is managed by the shelf management unit 200 is increased, the load of the shelf management unit 200 augments. Even though the load of the shelf management unit 200 augments, only the shelf management unit 200 can execute the survival conformation in the centralized management system, whereby the process of transmitting the response request message to each board, and the process of receiving the response message are delayed, and detection of the failure is delayed. With the redundancy switching function, a further delay in an operation of switching the active board over to the stand-by board after detecting the failure occurs because only the shelf management unit 200 of which the load has been increased can execute it.

On the other hand, in the distributed management system, the process of the survival confirmation and the redundancy switchover also is delayed when the load of the process that is executed in the board is increased temporally because the survival confirmation and the redundancy switchover are executed on each board.

For example, it is assumed that the board 500a is a switch, and when traffic that has to be transferred with this switch is increased at a level of a limit of a transfer capacity, the load of the board 500a augments. For this, the process of transmitting the heartbeat message for the survival confirmation and the redundancy switching process after detecting a failure, each of which is executed in the identical processing unit, are delayed, and it takes a longer time to recover the failure.

The second point at issue is that the board for the centralized management system and the board for the distributed management system cannot coexist in the centralized management system, and in the distributed management system, respectively. The reason is that the board for the centralized management system cannot execute the survival confirmation but for the centralized management system like the shelf management unit 200 of FIG. 10, and introducing the shelf management unit 200 causes the board for the distributed management to be recognized to be a failed board at any time because it has no function of responding to the response request message from the shelf management unit 200.

The third point at issue is that the system for assigning one part of the processing function to the other device, which is typified by that of the patent document 1 and the patent document 2, can be realized only on the assumption that each of the device in a function assignee side and the device in a function assignor side has an identical function and means. Thereby, all terminals need to have the identical function, which gives rise to a defect that the cost increases as a whole of the system.

Thereupon, the present invention has been accomplished in consideration of the above-mentioned problems, and an object thereof is to provide a technology of a management system that is capable of executing the process without a delay notwithstanding a change in a dynamic load, for example, a temporary increase in a load in the centralized management unit or in some board.

Further, an object of the present invention is to provide a technology of a management system that enables the board for the centralized management and the board for distributed management to coexist within the device in shifting to the distributed management system from the centralized management system responding to enlargement of a scale of the device.

Yet further, an object of the present invention is to provide a technology of a management system that is capable of coping with a change in a dynamic load by causing each device to realize the function executed by another device with a combination of the executable means or with the substitutable means without standardizing the processing ability and the processing means of each device of the system, and yet can be realized at a low cost.

### Means to Solve the Problem

A first invention for solving the aforementioned problems is a management system for managing an executing right of functions of a first device and a second device, said first device and said second being connected by means of a communication path enabling an exchange of information, characterized in that: said first device comprises the means for: notifying to the second device the function of the executing right that should be assigned from the first device; notifying data necessary for executing the function of said executing right to said second device; and in response to a notification about assignability of said executing right from said second device, notifying that said executing right is assigned to said second device; and said second device comprises the means for: receiving a notification about the function of the executing right being assigned from said first device; determining whether the function of said notified executing right is executable by combining the functions that can be executed within the second device, or is substitutable with the function that can be executed within the second device, and if it is determined that it is impossible, notifying unassignability to said first device; receiving data necessary for executing the function of said executing right from said first device, and determining whether the received data is data satisfactory for executing the function of said executing right; in a case where the function of said notified executing right is executable, and yet said received data is data satisfactory for executing the function of said executing right, notifying assignability of said executing right to the said first device; and accepting the executing right of said function from said first device.

The second invention for solving the above-mentioned problems is characterized in, in the above-mentioned first invention, comprising command relaying means for converting into data having a specification that conforms to the communication network for connecting the different devices.

The third invention for solving the above-mentioned problems is characterized in, in the above-mentioned first or second inventions, that said first device comprises means for dividing the function of the executing right that should be assigned into the functions that can be executed by a plurality of the second devices, notifying each divided function to a plurality of the second devices, and causing a plurality of the second devices to execute the function of the executing right that should be assigned from the first device.

The fourth invention for solving the above-mentioned problems is characterized in, in the above-mentioned first to third inventions, that said second device comprises means for, in a case where the function of said notified executing right is unexecutable only with the functions that can be executed within its own device, discovering another second device taking a charge of the function that is lacking, and executing the function of said notified executing right together with said second device.

The fifth invention for solving the above-mentioned problems is a management system for managing an executing right of a function between each of a plurality of devices and the other, said plurality of devices being connected by means of a communication path enabling an exchange of information, characterized in comprising the means for: notifying the function of the executing right that should be assigned; determining whether the function of said notified executing right is executable by combining the functions that can be executed within the device, or substitutable with the function that can be executed within the device, and if it is determined that it is impossible, notifying unassignability; notifying data necessary for executing the function of said executing right; receiving data necessary for executing the function of said executing right, and determining whether the received data is data satisfactory for executing the function of said executing right; in a case where the function of said notified executing right is executable, and yet said received data is data satisfactory for executing the function of said executing right, notifying assignability of said executing right; in response to a notification about assignability of said executing right, notifying an assignment of said executing right; and accepting an assignment of the executing right of said function.

The sixth invention for solving the above-mentioned problems is characterized in, in the above-mentioned fifth invention, that comprising command relaying means for converting into data having a specification that conforms to the communication network for connecting the different devices.

The seventh invention for solving the above-mentioned problems is characterized in, in the above-mentioned fifth or sixth inventions, comprising means for, in a case where the function of the executing right that should be assigned is unexecutable only with one device, dividing the function of said executing right that should be assigned into a plurality of the executable functions, and causing a plurality of the devices to execute each divided function.

The eighth invention for solving the above-mentioned problems is a device for mutually assigning an executing right of a predetermined function between devices, said devices being connected by means of a communication path enabling an exchange of information, characterized in comprising the means for: notifying to another device the function of the executing right that should be assigned; notifying data necessary for executing the function of said executing right to said another device; and in response to a notification about assignability of the executing right from said another device, assigning said executing right to said another device.

The ninth invention for solving the above-mentioned problems is characterized in, in the above-mentioned eighth invention, comprising command relaying means for converting into data having a specification that conforms to the communication network for connecting the different devices.

The tenth invention for solving the above-mentioned problems is characterized in, in the above-mentioned eighth or ninth inventions, comprising means for dividing the function of the executing right that should be assigned into the functions that can be executed by a plurality of the devices, notifying each divided function to a plurality of the devices, and causing a plurality of other devices to execute the function of the executing right that should be assigned.

The eleventh invention for solving the above-mentioned problem is a device for mutually assigning an executing right of a predetermined function between devices, said devices being connected by means of a communication path enabling an exchange of information, characterized in comprising the means for: receiving a notification about the function of the executing right that is assigned from another device; determining whether the function of said notified executing right is executable by combining the functions that can be executed within its own device, or substitutable with the function that can be executed within its own device, and if it is determined that it is impossible, notifying unassignability to the device having notified the function of said executing right; receiving data necessary for executing the function of said executing right from the device having notified the function of said executing right, and determining whether the received data is data satisfactory for executing the function of said executing right; in a case where the function of said notified executing right is executable, and yet said received data is data satisfactory for executing the function of said executing right, notifying assignability of said executing right to the device having notified the function of said executing right; and accepting the executing right of said function from the device having notified the function of said executing right.

The twelfth invention for solving the above-mentioned problem is characterized in, in the above-mentioned eleventh invention, comprising command relaying means for converting into data having a specification that conforms to the communication network for connecting the different devices.

The thirteenth invention for solving the above-mentioned problem is characterized in, in the above-mentioned eleventh or twelfth inventions, comprising means for, in a case where the function of said notified executing right is unexecutable only with the function that can be executed within its own device, discovering another device taking a charge of the function that is lacking, and executing the function of said notified executing right together with said another device.

The fourteenth invention for solving the above-mentioned problem is a management method of an executing right of a function between each of a plurality of devices and the other, said plurality of said devices being connected by means of a communication path enabling an exchange of information, characterized in: by the device from which the executing right should be assigned, notifying the function of the executing right that should be assigned, and data necessary for executing this function to another device; and causing the device having received the notification to determine whether the function of said notified executing right is executable by combining the functions that can be executed within the device, or substitutable with the function that can be executed within the device, and in a case where the function of said notified executing right is executable, and yet data necessary for executing the function of said executing right is reservable, assigning the executing right of the function to its device.

The fifteenth invention for solving the above-mentioned problem is characterized in, in the above-mentioned fourteenth invention, that in a case of making communication with the device connected to the communication network having a different specification, converting into data having a specification that conforms to the communication network to which the device makes a connection.

The sixteenth invention for solving the above-mentioned problem is characterized in, in the above-mentioned fourteenth or fifteenth inventions, that in a case where the function of the executing right that should be assigned is unexecutable only with one device, dividing the function of said executing right that should be assigned into a plurality of the executable functions, and causing a plurality of the devices to execute each divided function.

The seventeenth invention for solving the above-mentioned problem is a program of a device for mutually assigning an executing right of a predetermined function between devices, said devices being connected by means of a communication path enabling an exchange of information, characterized in causing said device to function as the means for: notifying to another device the function of the executing right that should be assigned; notifying data necessary for executing the function of said executing right to another device; and in response to a notification about assignability of the executing right from said another device, assigning said executing right to said another device.

The eighteenth invention for solving the above-mentioned problem is characterized in, in the above-mentioned seventeenth invention, that in causing said device to function as command relaying means for converting into data having a specification that conforms to the communication network for connecting the different devices.

The nineteenth invention for solving the above-mentioned problem is characterized in, in the above-mentioned seventeenth or eighteenth inventions, that in causing said device to function as means for dividing the function of the executing right that should be assigned into the functions that can be executed by a plurality of the devices, notifying each divided function to a plurality of the devices, and causing a plurality of other devices to execute the function of the executing right that should be assigned.

The twentieth invention for solving the above-mentioned problem is a program of a device for mutually assigning an executing right of a predetermined function between devices, said devices being connected by means of a communication path enabling an exchange of information, characterized in causing said device to function as the means for: receiving a notification about the function of the executing right being assigned from another device; determining whether the function of said notified executing right is executable by combining the functions that can be executed within its own device, or substitutable with the function that can be executed within its own device, and if it is determined that it is impossible, notifying unassignability to the device having notified the function of said executing right; receiving data necessary for executing the function of said executing right from the device having notified the function of said executing right, and determining whether the received data is data satisfactory for executing the function of said executing right; in a case where the function of said notified executing right is executable, and yet said received data is data satisfactory for executing the function of said executing right, notifying assignability of the said executing right to the device having notified the function of said executing right; and accepting the executing right of said function from the device having notified the function of said executing right.

The twenty-first invention for solving the above-mentioned problem is characterized in, in the above-mentioned twentieth invention, that in causing said device to function as command relaying means for converting into data having a specification that conforms to the communication network for connecting the different devices.

The twenty-second invention for solving the above-mentioned problem is characterized in, in the above-mentioned twentieth or twenty-first inventions, that in causing said device to function as means for, in a case where the function of said notified executing right is unexecutable only with the function that can be executed within its own device, discovering another device taking a charge of the function that is lacking, and executing the function of the said notified executing right together with said another device.

The twenty-third invention for solving the above-mentioned problem is a management system of an executing right of a function, characterized in comprising the means for: notifying the function of the executing right that should be assigned; determining whether the function of said notified executing right is executable by combining the functions that can be executed in a notifyee side, or substitutable with the executable function, notifying assignability of said executing right in a case where the function of said notified executing right is executable, and notifying unassignability in a case where it is unexecutable; in response to a notification about assignability of said executing right, notifying an assignment of said executing right; and accepting an assignment of the executing right of said function.

The twenty-fourth invention for solving the above-mentioned problem is a management system of an executing right of a function between each of a plurality of devices and the other, said plurality of said devices being connected by means of a communication path enabling an exchange of information, characterized in comprising the means for: notifying the function of the executing right that should be assigned; determining whether the function of said notified executing right is executable by combining the functions that can be executed within the device, or substitutable with the function that can be executed within the device, notifying assignability of said executing right in a case where the function of said notified executing right is executable, and notifying unassignability in a case where it is unexecutable; in response to a notification about assignability of said executing right, notifying an assignment of said executing right; and accepting an assignment of the executing right of said function.

The twenty-fifth invention for solving the above-mentioned problem is characterized in, in the above-mentioned twenty-fourth invention, comprising command relaying means for converting into data having a specification that conforms to the communication network for connecting the different devices.

The twenty-sixth invention for solving the above-mentioned problem is characterized in, in the above-mentioned twenty-fourth or twenty-fifth inventions, that in a case where the function of the executing right that should be assigned is unexecutable only with one device, dividing the function of said executing right that should be assigned into a plurality of the executable functions, and causing a plurality of the devices to execute each divided function.

The twenty-seventh invention for solving the above-mentioned problem is a management method of an executing right of a function, characterized in: notifying the function of the executing right that should be assigned; determining in a notifyee side whether the function of said notified executing right that is executable by combining the executable functions, or is substitutable with the executable function; and in a case where the function of said notified executing right is executable, assigning the executing right of the function to its device.

The twenty-eighth invention for solving the above-mentioned problem is a management method of an executing right of a function between each of a plurality of devices and the other, said plurality of said devices being connected by means of a communication path enabling an exchange of information, characterized in: by the device from which the executing right should be assigned, notifying to another device the function of the executing right that should be assigned; determining in the device having received the notification whether the function of said notified executing right is executable by combining the functions that can be executed within the device, or substitutable with the function that can be executed within the device, and in a case where the function of said notified executing right is executable, assigning the executing right of the function to its device.

The twenty-ninth invention for solving the above-mentioned problem is a device for mutually assigning an executing right of a predetermined function between devices, said devices being connected by means of a communication path enabling an exchange of information, characterized in comprising the means for: notifying to another device the function of the executing right that should be assigned; and in response to a notification about assignability of the executing right from said another device, assigning said executing right to said another device.

The thirty invention for solving the above-mentioned problem is a device for mutually assigning an executing right of a predetermined function between devices, said devices being connected by means of a communication path enabling an exchange of information, characterized in comprising the means for: receiving a notification about the function of the executing right being assigned from another device; determining whether the function of said notified executing right is executable by combining the functions that can be executed within its own device, or substitutable with the function that can be executed within its own device, in a case where the function of said notified executing right is executable, notifying assignability of said executing right to the device having notified the function of said executing right, and in a case where it is unexecutable, notifying unassignability of said executing right to the device having notified the function of said executing right; and accepting the executing right of said function from the device having notified the function of said executing right.

An advantageous operation of the present invention will be explained.

As shown in FIG. 1, the management system of the present invention is configured of a right management system 1, a shelf 4, a shelf management unit 2 for managing the shelf, and boards 5a to 5d inserted into the shelf. Further, the right management system 1 and the shelf management unit 2 are connected by means of a communication path so that they can exchange data. Further, the shelf management unit 2 and each of the boards 5a to 5d are also connected by means of the communication path enabling data to be exchanged.

When the right management system 1 selects the function, of which an executing right is assigned to the board 5a, from among functions that the shelf management unit 2 has, the shelf management unit 2 notifies to the board 5a identification information (for example, a name of the function, ID information for identifying the function, etc.) for identifying the function being assigned. In the board 5a, the board management unit 3a determines whether the function that is specified with the notified identification information is executable by combining the functions that can be executed in its own device, or with the substitutable function. For example, in a case where the notified function is a failure recovery function, there exist a survival confirmation function for making a confirmation of life or death of the board and a redundancy switching function for switching the active board over to the stand-by board at the time of occurrence of a failure as a function that can be executed by the board 5a, and yet in a case where combining two functions enables the failure recovery function to be executed, the board management unit 3a consents to an assignment of the executing right of the failure recovery function.

Further, in a case where the notified function is an automatic configuration discovery function for directly inquiring each board about a configuration, the board management unit 3a consents to an assignment of the executing right of the automatic configuration discovery function if the automatic configuration discovery function is substitutable by means of another method in the board 5a.

Thereafter, the board management unit 3a obtains data necessary for executing its function from the shelf management unit 2, and accepts the executing right of the function if the obtained data is satisfactory data.

Additionally, with transmission/reception of data necessary for executing the function, it is also acceptable that some amount of data is transmitted together with identification information for identifying the function, and data of a difference with the already transmitted data is transmitted after it has been determined that the function is realizable.

Further, each of the devices assumes a configuration identical to that of the other, thereby enabling the function to be assigned in a bi-direction of the device.

Further, in notifying information between the devices via a communication network such as Internet, making a configuration so that command relaying means converts information into an IP packet or formatted information specified by the communication path such as an Ether frame enables the function to be assigned by means of the communication network such as Internet also in a case of connecting the devices of which the installation locations are far away from each other.

### EFFECTS OF THE INVENTION

In accordance with the present invention, in the management system for managing two devices or more, the centralized management unit for executing the centralized management notifies to the device management unit for managing each device the effect that some function should be assigned, the device management unit selects the function that is actually executed within the device, and acquires information necessary for execution from the centralized management unit, and the centralized management unit notifies a start of the function in the device management unit, thereby enabling the execution location of the function to be dynamically shifted from the centralized management unit to the device management unit that is of distributed management responding to a situation of the load.

Further, the centralized management unit confirms in the first place whether the right is assignable for the device management unit, whereby the device for the centralized management can maintain the failure recovery function by the centralized management unit to assign the function to the device for the distributed management also in a case where the device for the distributed management coexists in the conventional centralized management system. This enables coexistence of the device for the centralized management and the device for the distributed management coexist, and the conventional device for the centralized management can be used consecutively also in shifting to the distributed management system from the centralized management system due to enlargement of a scale.

Further, each of the centralized management unit and the device management unit includes notification accepting means of information and execution function selecting means, thereby enabling both of the centralized management unit and the device management unit to execute the function of notifying the right assignment and the function of accepting it, so it becomes possible to assign the right in a bi-direction, i.e. a direction from the centralized management unit to the device management unit, and a direction from the device management unit to the centralized management unit. For this, also in a case where the load has concentrated upon a specific device, assigning the function to the centralized management unit allows the load to be distributed, which enables the stabilized operation.

Further, a kind of the function being assigned, information being used by the function, and a timing at which the function is assigned can be notified between the devices, whereby the executing right of the function can be shifted between the devices. Further, it can be avoided to assign the distributed function to the device that corresponds only to the centralized management system because it is confirmed in the first place whether the function being assigned is executable. Further, so as to realize the function being assigned, a plurality of the functions are combined in some cases, and the function is executed substitutively in some cases, whereby the function can be assigned also in a case where each of the devices differs from the other in the technique of executing the function.

### BRIEF DESCRIPTION OF THE DRAWINGS

FIG. 1 is an entire configuration view of the devices that the management system of the present invention operates.

FIG. 2 is a block diagram of the management system having the part shown in details that relates to the right management system 1, the shelf management unit 2, and the board 5a shown in FIG. 1.

FIG. 3 is a view having one example of a using information DB 21 shown.

FIG. 4 is a view having one example of a reservation right DB 22 shown.

FIG. 5 is a view having one example of an executable function DB 31 shown.

FIG. 6 is a flowchart illustrating an operation of the management system in a first embodiment of the present invention.

FIG. 7 is a view illustrating a configuration of a second embodiment.

FIG. 8 is a view illustrating a configuration of a third embodiment.

FIG. 9 is a view for explaining the third embodiment.

FIG. 10 is a general block diagram of an information processing system having the shelf management unit 2a in accordance with the present invention implemented.

FIG. 11 is a view for explaining the prior art.

FIG. 12 is a view for explaining the prior art.

FIG. 13 is a view illustrating a configuration of a fourth embodiment of the present invention.

FIG. 14 is a view having one example of a function division information DB 210 shown.

FIG. 15 is a view having one example of a board reservation function DB 211 shown.

FIG. 16 is a view illustrating a configuration of a fifth embodiment of the present invention.

FIG. 17 is a view having one example of an executable function DB 31 shown.

### DESCRIPTION OF NUMERALS

1 right management system
2 shelf management unit
3 board management unit
4 shelf
5 board
11 assignment function selecting means
12 input means
21 and 32 using information DBs
22 and 33 reservation right DBs
24 assignment function notifying means
25 using information notifying means
26 right assignment notifying means
27 command relaying means
31 executable function DB
34 execution function selecting means
35 assignment function accepting means
36 using information accepting means
37 right assignment accepting means
38 function executing means
41 assignment function notification accepting means
42 using information notification accepting means
43 right assignment notification accepting means

### BEST MODE FOR CARRYING OUT THE INVENTION

Embodiments of the present invention will be explained in details by making a reference to the accompanied drawings. Additionally, in the following explanation, a database is refereed to as “DB” for short.

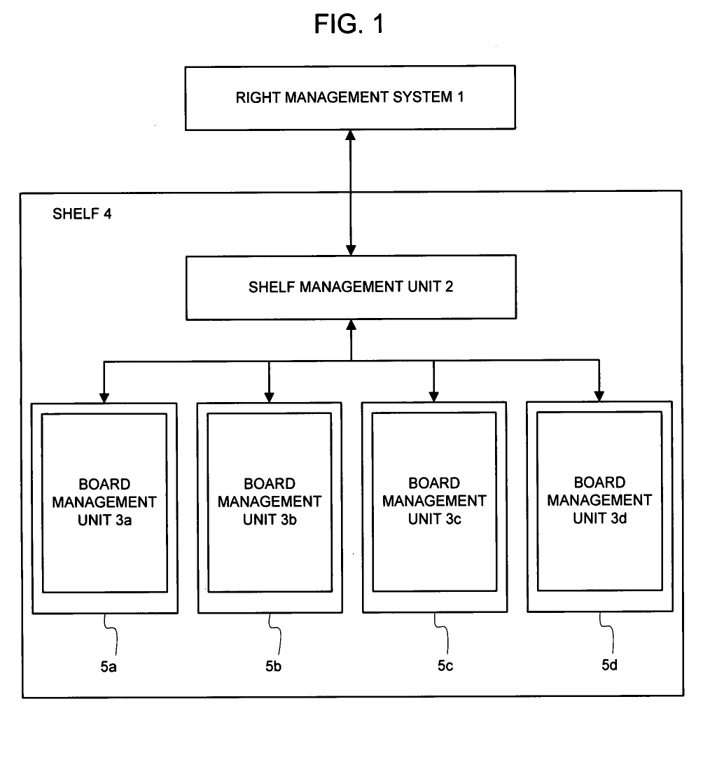

FIG. 1 shows an entire configuration of the devices that the management system of the present invention operates.

The management system of the present invention is configured of a right management system 1, a shelf 4, a shelf management unit 2 for managing the shelf, and boards 5a to 5d inserted into the shelf. Further, the right management system 1 and the shelf management unit 2 are connected by means of a communication path so that they can exchange data. Further, the shelf management unit 2 and each of the boards 5a to 5d are also connected by means of the communication path enabling data to be exchanged.

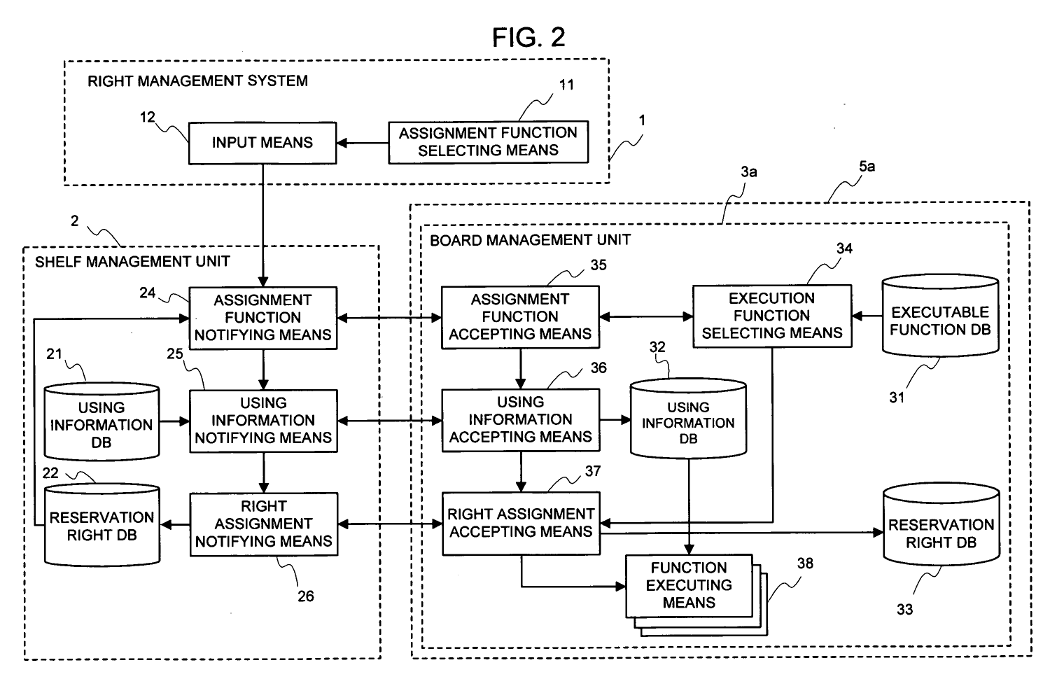

FIG. 2 is a block diagram of the management system having the part shown in details that relates to the right management system 1, the shelf management unit 2, and the board 5a shown in FIG. 1. Additionally, with the board, only board 5a is shown in the figure; however the other board has a similar configuration.

The right management system 1 includes assignment function selecting means 11 and input means 12.

The assignment function selecting means 11 selects the function of which the executing right is assigned to the board 5a from among the functions that the shelf management unit 2 has. As a method of selecting the function, there exists the method of selecting the function according to information set by a manager, and the method in which the assignment function selecting means selects the function being assigned by collecting load information from the shelf management unit and the board management unit so that the load distribution is enabled.

The input means 12 notifies the function selected by the assignment function selecting means 11 to the shelf management unit 2.

The shelf management unit 2 includes a using information DB 21, a reservation right DB 22, assignment function notifying means 24, using information notifying means 25, and right assignment notifying means 26.

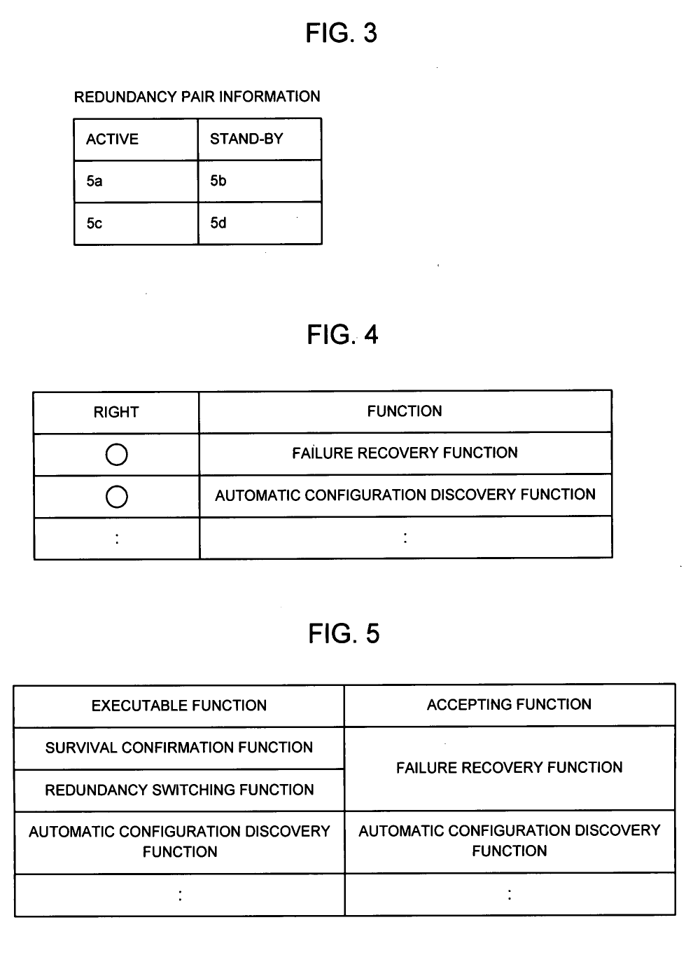

The using information DB 21 has information registered that is required in executing the function being assigned. For example, information saying that the board 5a is switched over to the board 5b is stored in a case where “the redundancy switching function” has been selected as a function being assigned. An example of the using information DB 21 is shown in FIG. 3. In FIG. 3, the using information DB 21 has information saying that the board 5a is switched over to the board 5b in the case that the board 5a has failed, and information saying that the board 5c is switched over to the board 5d in the case that the board 5c has failed registered as information that is used in the case that “the redundancy switching function” has been selected as a function being assigned.

In the reservation right DB 22 are stored a name of the function that can be executed by the shelf management unit 2, and information as to whether the shelf management unit 2 reserves the executing right for each function. An example of the reservation right DB 22 is shown in FIG. 4. In FIG. 4, it has been registered that the shelf management unit 2 reserves the executing right for the failure recovery function and the automatic configuration discovery function.

The assignment function notifying means 24 notifies to the board 5a identification information (for example, a name of the function, ID information for identifying the function, etc.) for identifying the function input from the right management system 1 that is to be assigned, and receives a response as to whether the right is assignable from the board 5a.

The using information notifying means 25 notifies to the board 5a information that is required in executing the function notified by the assignment function notifying means 24. It acquires information that the function of which the right is assigned necessitates from the using information DB 21.

The right assignment notifying means 26 notifies to the board 5a a timing at which the right is assigned. After assigning the right, it updates the reservation right DB 22, and stores that the right has been abandoned in the shelf 4.

The board 5a includes a board management unit 3a for managing the executing right. This board management unit 3a includes an executable function DB 31, a using information DB 32, a reservation right DB 33, execution function selecting means 34, assignment function accepting means 35, using information accepting means 36, right assignment accepting means 37, and function executing means 38.

The executable function DB 31 has a name of the function, which can be executed by the board 5a (can be executed by the function executing means 38) and a name of the function, which can be obtained by combining these functions, stored correspondingly. An example of the executable function DB 31 is shown in FIG. 5. In FIG. 5, the survival confirmation function for making a confirmation of life or death of the board and the redundancy switching function for switching the active board over to the stand-by board at the time of occurrence of the failure have been registered, and it is shown that combining these two functions enables the failure recovery function to be executed. Additionally, the survival confirmation function is a function for exchanging the heartbeat message between the designated boards to recognize that the failure has occurred at a time point that this heartbeat message has come to halt. Further, the redundancy switching function is a function for switching over to the pre-set stand-by board when the failure of the board is detected.

Further, the executable function DB 31 has the automatic configuration discovery function as well registered. With the automatic configuration discovery function, there exist several techniques depending upon a kind of the device. For example, with the automatic configuration discovery function in the shelf management unit 2, the shelf management unit 2 directly transmits a board information request message to the boards 5a to 5d each of which is an object of management of the shelf management unit 2, and each of the boards 5a to 5d notifies a slot position into which the board has been inserted, and a kind of the board to the shelf management unit as a response, thereby enabling a configuration within the shelf to be discovered automatically and centralizedly.

On the other hand, the automatic configuration discovery function by the board management unit 3a is a function of, by causing each board to notify configuration information to the board that exists in the neighboring slot, discovering a configuration within the shelf. In the first place, the board management unit 3a notifies configuration information that is comprised of a slot position and a kind of the board to the board 5b that is located in the neighboring slot. The board 5b having acquired the configuration information of the board 5a adds configuration information of the board 5b itself to the configuration information of the board 5a, and further notifies the configuration information to the neighboring board 5c. Likewise, the board 5c as well adds its own configuration information to the acquired configuration information, and notifies it to the board 5d. The board 5d adds its own configuration information to the acquired configuration information, determines that its own slot position is a shelf end, and notifies the configuration information to the board 5a. At this time, the entire configuration information within the shelf can be discovered automatically and distributedly because the configuration information acquired by the board 5a includes the configuration information of the boards 5a to 5d.

In such a manner, the executable function DB 31 has the function, which can be executed by the board 5a, and the function, which is substitutable with this function, stored correspondingly so that even in a case where the method of realizing the function in the shelf management unit 2 and the method of realizing the function in the board management unit 3a differ from each other, the execution function selecting means 34 can select the centralized automatic configuration discovery function, which has been assigned, from among the distributed automatic configuration discovery functions that are executable on the board 5a.

The using information DB 32, similarly to the using information DB 21, has information stored that is used at the time of executing the function of which the right has been assigned from the shelf. With the redundancy configuration switching function, the using information DB 32 has a correspondence relation stored between the active board and the stand-by board for each board.

The reservation right DB 33, similarly to the reservation right DB 22, has the function, of which the executing right is reserved by the board 5a, stored. Additionally, by using the database having names of all functions registered that can be executed by the board 5a, and having existence of the executing right of the board 3a for each function registered, it is also possible to realize the executable function DB 31 and the reservation right DB 33 with one database.

The assignment function accepting means 35 accepts a notification for designating the function of which the executing right is to be assigned from the shelf management unit 2, for example, a notification about identification information (for example, a name of the function, ID information for identifying the function, etc.).

The execution function selecting means 34 selects the function, with which the function that is specified with the identification information received by the assignment function accepting means 35 can be executed, from among the functions stored in the executable function DB 31, and notifies the assignment function accepting means 36 that the function being assigned can be executed by the board 3a. The identification information such as a name of the function selected herein is notified to the right assignment accepting means 37. Further, when the execution function selecting means 34 determines that the function being assigned from the shelf management unit 2 can not be executed by the board 5a, it notifies the effect that the function is unexecutable to the assignment function accepting means 36.

The using information accepting means 36 acquires information, which is used in the function being assigned, from the using information notifying means 25. The using information acquired herein is stored in the using information DB 32, and is used by the function executing means 38 at the time of executing the function.

The right assignment accepting means 37 accepts a trigger of the right assignment that is notified by the right assignment notifying means 26. Upon accepting the trigger of the right assignment, it updates to the reservation right DB 33 so that the effect that the executing right of the function has been shifted to the board 5a is recorded.

The function executing means 38, which is means for realizing the function that can be executed by the board, is, for example, means for executing the survival confirmation function and the redundancy switching function.

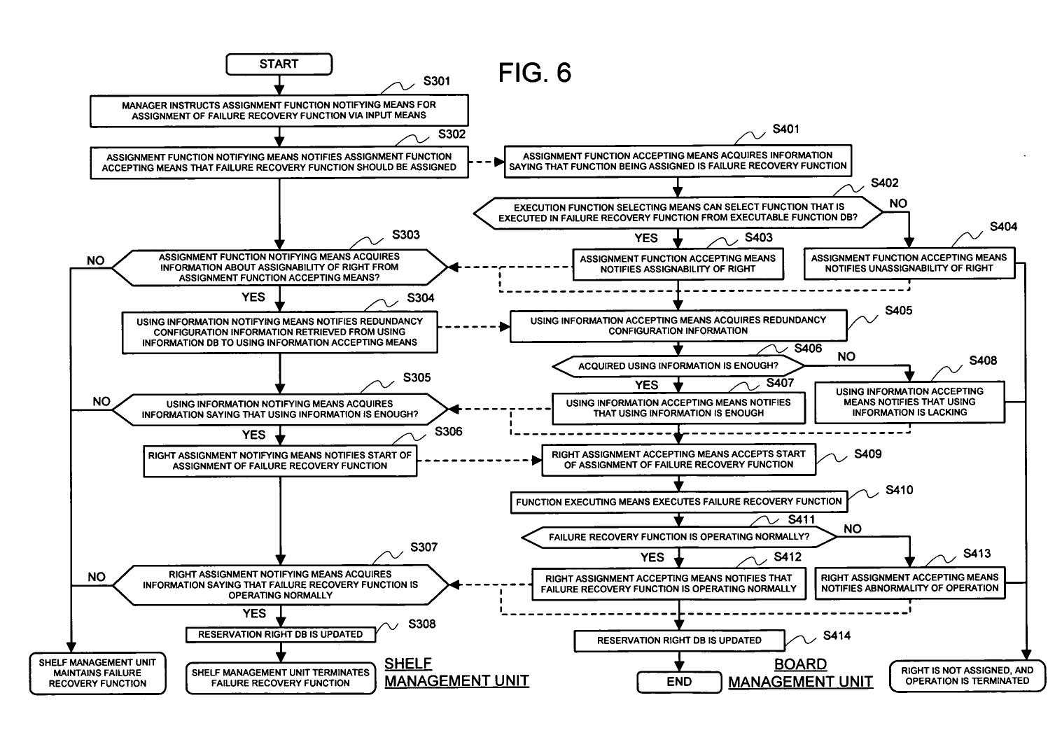

Next, an operation of the first embodiment of the present invention will be explained in details by making a reference to FIG. 6.

FIG. 6 is a flowchart illustrating an operation of the management system in the first embodiment of the present invention. Hereinafter, the case of assigning the failure recovery function to the board 5a from the shelf management unit 2 is exemplified to explain an operation of the first embodiment of the present invention in details.

In the first place, in a step S301, the assignment function selecting means 11 selects the failure recovery function as a function being assigned to the board 5a from the shelf management unit 2, and the input means 12 notifies identification information such as a name of this selected failure recovery function to the assignment function notifying means 24. As a method of selecting the function by the assignment function selecting means 11, there exist the method in which a manager selects the pre-registered function, the method in which a load situation and a traffic content of the shelf and the board are collected and the assignment function selecting means 11 automatically notifies identification information such as a name of the function being assigned if the load or the traffic exceeds a certain value, and the method in which the assignment function selecting means 11 automatically notifies identification information such as a name of the function being assigned if the number of an object of management exceeds a certain value.

In a step S302, the assignment function notifying means 24 notifies that the function being assigned to the assignment function accepting means 35 of the board management unit 3a of the board 5a is the failure recovery function.

In a step S401, the assignment function accepting means 35 acquires information saying that function being assigned from the assignment function notifying means 24 is the failure recovery function, and notifies it to the execution function selecting means 34.

In a step S402, the execution function selecting means 34 searches the executable function DB 31, and selects the function necessary for executing the failure recovery function in the board 3a. The executable function DB 31 has names of the functions registered that can be executed in the board 5a as shown in FIG. 5; however the correspondence relation with the function designated by the shelf management unit 2 is not limited to a one-versus-one relation. For this, a configuration is made so that the execution function selecting means 34 establishes a correspondence relation, thereby enabling the assignment of the function to be executed even in a case where an assignor side of the right and an assignee side differ from each other in the technique of executing the function, for example, between the shelf management unit 2 and the board management unit 3a. In the present invention, the executable function DB 31 has names of the functions that can be executed by the board 5a, and a name of the executable function that is obtained by combining these function registered, and in a case where identification information such as a name of the function designated by the shelf management unit 2 is the failure recovery function, the execution function selecting means 34 selects a combination of the survival confirmation function and the redundancy switching function as the function that corresponds to the failure recovery function, based upon the executable function DB 31.

In such a manner, when it is determined in the execution function selecting means 34 that the function being assigned to the board 5a is executable, the assignment function accepting means 35 notifies the assignment function notifying means 24 that the right is assignable in a step S403. But in a case where there is no function being executed by the board 3a, the assignment function accepting means 35 notifies the assignment function notifying means 24 that the right is unassignable in a step S404.

Upon accepting the notification saying that the right is assignable in a step S303, the assignment function notifying means 24 notifies to the board 5a information that is used at the moment that the function being assigned operates in a step S304. With an example of the survival confirmation function, information saying that an exchange partner of the heartbeat message of the board 5a is the board 5b is used. Further, with the redundancy switching function, information saying that the stand-by board for the active board 5a is the board 5b is used. These items of the using information have been registered in the using information DB 21, and the using information notifying means 25 retrieves information necessary from this using information DB 21, and notifies it to the using information accepting means 36.

In a step S405, the using information accepting means 36 acquires information about the board that becomes an exchange partner of the heartbeat message that is used at the time of executing the failure recovery function, and the stand-by board. In a step S406, the using information accepting means 36 determines whether the using information acquired from the shelf management unit 2 is information enough for executing the failure recovery function.

In an example of this explanation, information about the board exchanging the heartbeat message and the stand-by board is information enough in executing the failure recovery function. For this, in a step S407, the using information accepting means 36 notifies the effect that the using information is enough to the using information notifying means 25. If the using information is not enough, in a step S408, it notifies the using information notifying means 25 that the using information is lacking, and terminates the operation without executing the right assignment. Herein, in a case where the using information is not enough, it is also possible that the using information accepting means 36 requests of the using information notifying means 25 information that is lacking, and the using information notifying means 25 provides this requested information, thereby allowing the right assignment operation to be maintained, which is not shown in the figure.

Further, it is also possible that it is not that the shelf management unit 2 firstly notifies the using information, but that the using information accepting means 36 of the board management unit 3a firstly requests the using information necessary of the using information notifying means 25, which notifies the using information responding to a request.

In a step S305, the using information notifying means 25 determines the effect that the using information notified to the board management unit 3a is enough from a response of the board management unit 3a. When the using information notified to the board management unit 3a is enough, the right assignment notifying means 26 notifies a right assignment start of the failure recovery function to the right assignment accepting means 37 in a step S306. If it has acquired a notification saying the effect that the using information is lacking, the failure recovery function is executed consecutively in the shelf management unit 2, and an assignment to the board management unit 3a is stopped.

In the board management unit 3a, in a step S409, the right assignment accepting means 37 acquires an assignment start of the failure recovery function. In a step S410, the function executing means 38 executes the survival confirmation function and redundancy switching function selected by the execution function selecting means 34. The function executing means 38 can execute the function that can be executed by the board 5a, for example, the survival confirmation function and the redundancy switching function.

In a step S411, the function executing means 38 confirms whether the assigned failure recovery function is operating normally on the board 5a. In the step S411, the function executing means 38 makes it a rule to confirm whether these two functions are operating normally because the failure recovery function is realized with two functions of the survival confirmation function and the redundancy switching function on the board 5a. When the normal operation has been confirmed, in a step S412, the right assignment accepting means 37 notifies the effect that the failure recovery function is operating normally to the right assignment notifying means 26. If the failure recovery function does not operate normally, in a step S413, the right assignment accepting means 37 notifies operational abnormality, and the operation is terminated without assigning the executing right of the failure recovery function to the board 5a.

When the normal operation of the failure recovery function on the board 5a is confirmed, in a step S414, the failure recovery function is added to the reservation right DB 33 as a function of which the executing right is reserved by the board 5a, and the operation of assigning the right of the failure recovery function of the board management unit 3a side that is executed by the shelf management unit 2 is terminated.

In the shelf management unit 2, the right assignment notifying means 26 determines in a step S307 whether the failure recovery function is operating normally on the board 5a from a response by the right assignment accepting means 37. When it is determined that it is operating normally, in a step S308, the failure recovery function is deleted from the reservation right DB 22 having the functions registered of which the executing right is reserved by the shelf management unit 2, the failure recovery function in the shelf management unit 2 is stopped, and the right assignment operation is terminated.

In the above explanation, the procedure of assigning the function from the shelf management unit 2 to the board management unit 3a was explained; however exchanging the means and database that are reserved by the shelf management unit 2 for that of the board management unit 3a each of which is shown in FIG. 2 also makes it possible to shift the function from the board management unit 3a to the shelf management unit 2.

In such a manner, the assignment function notifying means 24 notifies which function, out of the functions managed centralizedly by the shelf management unit 2, is assigned to the board management units 3a to 3d, the using information notifying means 25 notifies information such as the redundancy configuration necessary for executing the function, the right assignment notifying means 26 matches a timing of a function stop in the shelf management unit 2 with a timing of a function start in the board management unit, thereby enabling the execution location of the function to be shifted dynamically from the shelf management unit that is of centralized management to the board management unit that is of distributed management responding to a situation of the load. This enables a concentration of the load upon the shelf management unit 2 and a specific board to be avoided.

Further, the assignment function notifying means 24 of the shelf management unit 2 firstly confirms whether the right is assignable for the board management unit, whereby the board for the centralized management can maintain the failure recovery function by the shelf management unit 2 to assign the function of the failure recovery to the board for the distributed management even in a case where the board for the distributed management coexists in the conventional centralized management system. With this, a coexistence of the board for the centralized management and the board for the distributed management is enabled, and the conventional board for the centralized management can be used continuously also in shifting from the centralized management system to the distributed management system due to enlargement of a scale.

The second embodiment of the present invention will be explained.

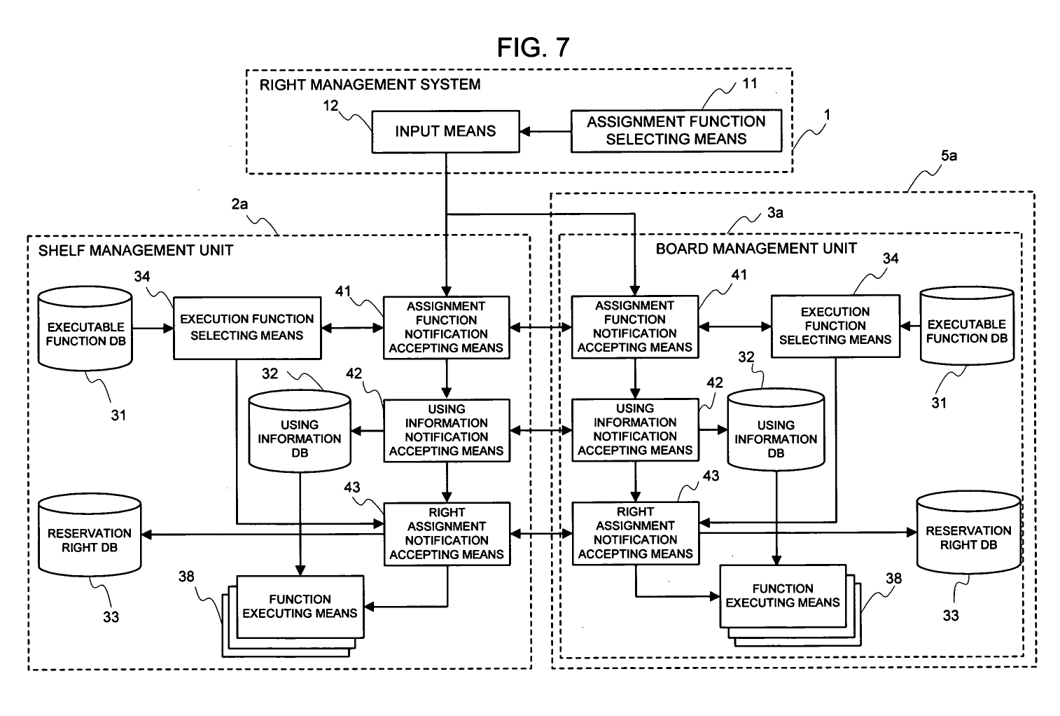

A basic configuration of the second embodiment of the present invention is identical to that of the first embodiment as shown in FIG. 7 except that the assignment function accepting means 35, the using information accepting means 36, the right assignment accepting means 37 within the board management unit 3a shown in FIG. 2 are changed to assignment function notification accepting means 41, using information notification accepting means 42, and right assignment notification accepting means 43, respectively. Further, a shelf management unit 2a also includes the means and database in the inside thereof that are identical to ones that are included in the inside of the board management unit 3a. In such a manner, the shelf management unit 2a also includes the means and database identical to that of the board management unit 3a, thereby enabling an assignment of the function in a bi-direction between the shelf management unit 2a and the board management unit 3a.

Hereinafter, a configuration of the second embodiment of the present invention will be explained by making a reference to FIG. 7. A different point with the configuration of the first embodiment shown in FIG. 2 lies in a point that the assignment function accepting means 35, the using information accepting means 36, the right assignment accepting means 37 are changed to the assignment function notification accepting means 41, the using information notification accepting means 42, and the right assignment notification accepting means 43, respectively, and the means and the database other than these are identical to that of the first embodiment, so the explanation thereof is omitted herein.

The assignment function notification accepting means 41, which has the functions of both of the assignment function notifying means 24 and the assignment function accepting means 35 shown in FIG. 2, not only can notify identification information such as a name of the function being assigned, but also can notify identification information such as a name of the notified function to the execution function selecting means 34.

The using information notification accepting means 42, which has the functions of both of the using information notifying means 25 and the using information accepting means 36 shown in FIG. 2, not only can acquire but also can register information like the redundancy configuration, which is used in executing the function being assigned, from the using information database.

The right assignment notification accepting means 43, which has the functions of both of the right assignment notifying means 26 and the right assignment accepting means 37 shown in FIG. 2, not only can notify a timing at which the right is assigned, but also can cause the function executing means to execute the function selected by the execution function selecting means 34 upon receipt of an assignment notification, and can update the right reservation DB 33.

Next, an operation of the second embodiment of the present invention will be explained.

At first, in a case of assigning the right from the shelf management unit 2a to the board management unit 3a, an operation identical to that of the flowchart signifying the operation of the first embodiment shown in FIG. 6 is performed. However, attention should be paid to that the assignment function notifying means 24, the using information notifying means 25, and the right assignment notifying means 26 are changed to the assignment function notification accepting means 41, the using information notification accepting means 42, and the right assignment notification accepting means 43 in the shelf management unit 2a, respectively, and the assignment function accepting means 35, the using information accepting means 36, and the right assignment accepting means 37 are changed to the assignment function notification accepting means 41, the using information notification accepting means 42, and the right assignment notification accepting means 43 in the board management unit 3a, respectively.

Contrarily, in a case of assigning the right from the board management unit 3a to the shelf management unit 2a, in the flowchart shown in FIG. 6, the board management unit 3a performs the steps S301 to S308, and the shelf management unit 2a performs the steps S401 to S414.

In such a manner, in the second embodiment of the present invention, each device includes the notification accepting means of information, the execution function selecting means 34, the function executing means 38, and each database, and both of the shelf and the board can execute the function of notifying the right assignment and the function of accepting it, thereby enabling the right to be assigned in a bi-direction, i.e. a direction from the shelf to the board, and a direction from the board to the shelf.

Next, the third embodiment of the present invention will be explained.

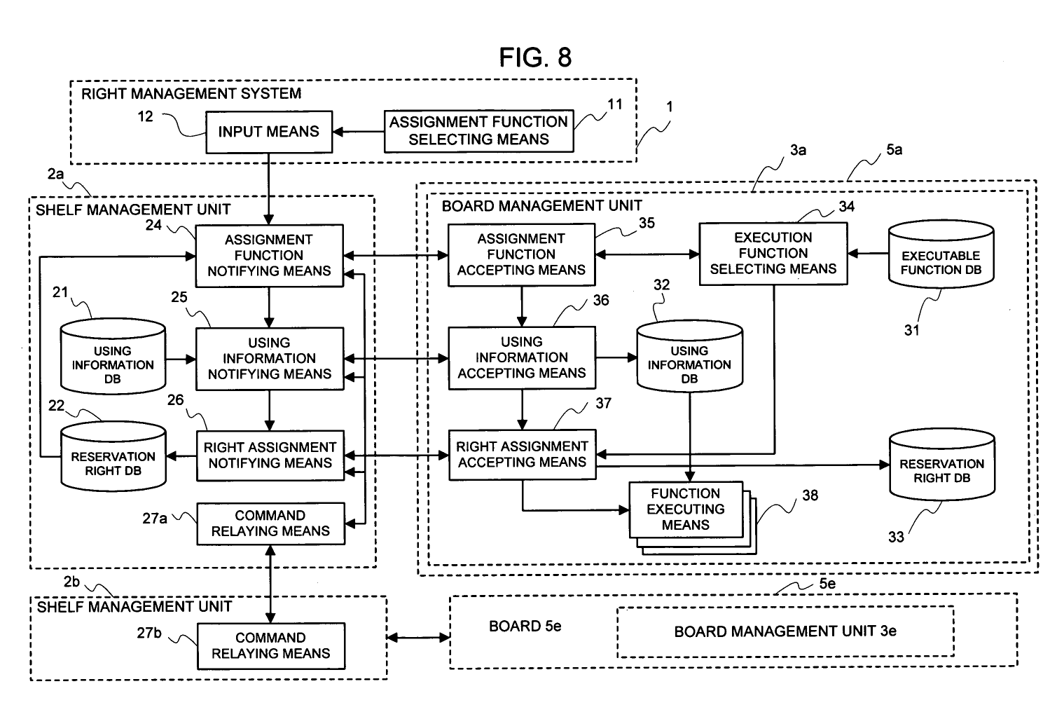

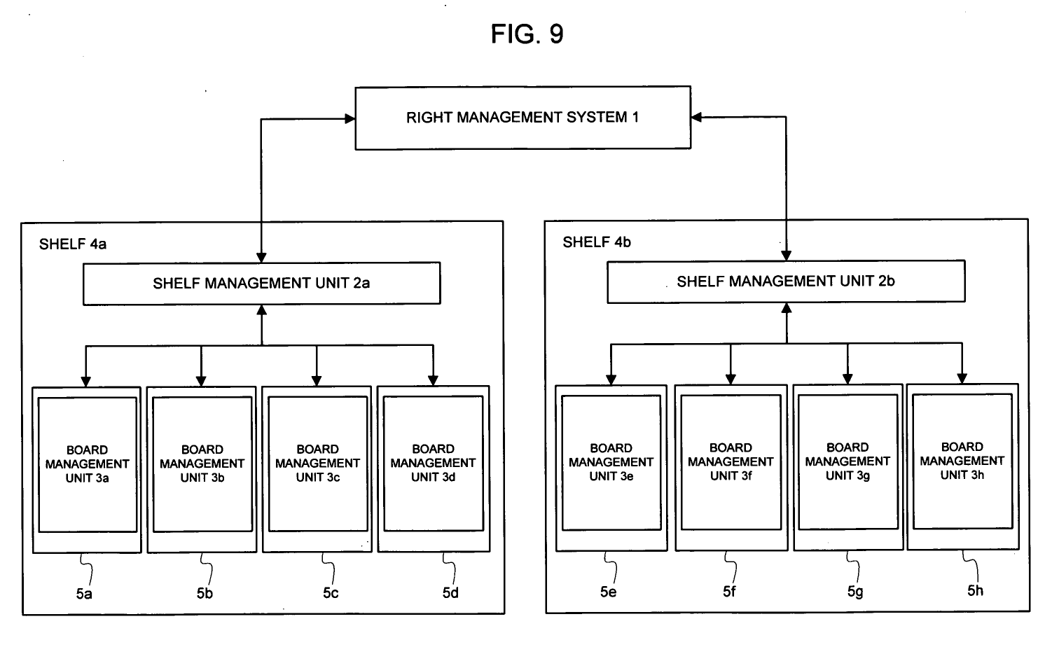

A basic configuration of the third embodiment of the present invention is identical to that of the first embodiment; however adding command relaying means 27a to the shelf management unit 2a as shown in FIG. 8 enables a right assignment between each of a plurality of the shelves and the other. For example, in a case where, as shown in FIG. 9, two shelves of a shelf 4a and a shelf 4b exist, the shelf management unit 2a executes the survival confirmation of boards 3a to 3d, and a shelf management unit 2b executes the survival confirmation of boards 3e to 3h, it follows that the shelf management unit 2a can assign the right to the board 3e within the shelf 4b so that the board 3e exchanges the heartbeat message with the boards 3a to 3d to execute the survival confirmation function.

Hereinafter, a configuration of the third embodiment of the present invention will be explained by making a reference to FIG. 8. A basic configuration is identical to that of the first embodiment shown in FIG. 2 except that the command relaying means 27a is added newly to the shelf management unit 2a. The shelf management unit 2b, which also has the means and database identical to that of the shelf management unit 2a, is identical to the shelf management unit 2a, so its description is omitted. Further, likewise, the board management unit 3e, which also has the means and database identical to that of the board management unit 3a, is identical to the board management unit 3a, so its description is omitted.

The command relaying means 27a, which is connected to the assignment function notifying means 24, the using information notifying means 25, the right assignment notifying means 26, respectively, can exchange information therewith. Further, the command relaying means 27a is connected to command relaying means 27b as well within the shelf 2b, and information between these is exchangeable. Such a connection between the command relaying means of which the shelf differs is not limited to a point-to-point connection, and the command relaying means may be connected via the network such as Internet and an Ethernet (Trademark Registered) network. In a case of connection via the network such as Internet in such a manner, the command relaying means 27a and 27b are caused to have a function of encapsulating information being exchanged into formatted information that is transferable via the network between the command relaying means, for example, the IP packet and the Ether frame, or contrarily, a function of taking out information from the IP packet and the Ether frame, thereby also enabling an information exchange via the network.

An operation of assigning the executing right to a board management unit 3e from the shelf management unit 2a is basically identical to that of the first embodiment shown in the flowchart shown in FIG. 6, so a reference to the flowchart of FIG. 6 is made for explanation.

In the step S302, the shelf management unit 2a notifies that the function, which is to be assigned to the board management unit 3a, is the failure recovery function, and simultaneously therewith, notifies that the function, which is to be assigned to the board management unit 3e, is the failure recovery function. At this time, the command relaying means 27a encapsulates this information into the IP packet or the Ether frame. In a case where a format identical to that of the information exchange between the shelf management unit and the board management unit can be used between the shelves, there is no necessity for encapsulating information.

Upon receipt of the IP packet or the Ether frame transmitted from the shelf management unit 2a in the command relaying means 27b, the shelf management unit 2b including a board 5e takes out information associated with the right assignment therefrom, and notifies it to the assignment function accepting means. Thereafter, the steps S401 and S402 are performed in the board management unit 3e. In the steps S403 or S404, a response, which is returned to the shelf management unit 2a from the board management unit 3e via the shelf management unit 2b, is encapsulated in the command relaying means 27b also at this time, and is sent.

Such information exchange between the shelves using the command relaying means 27a and 27b is made in the steps S302, S304, S306, S403, S404, S407, S408, S412, and S413 in the flowchart of FIG. 6. The board management unit 3e performs the operation similar to that of the flowchart of the board management unit 3a shown in FIG. 6, and uses the command relaying means 27b when notifying information to the shelf management unit that exists in the different shelf.

As mentioned above, making an information exchange between the different shelves by means of the command relaying means 27a and 27b enables an assignment of the function spanning a plurality of the shelves. Herein, the configuration that was obtained by adding the command relaying means to that of the first embodiment was explained, and the configuration as well that is obtained by adding the command relaying means to the configuration of the second embodiment shown in FIG. 7 can obtain the effect of the present invention.

Next, the fourth embodiment of the present invention will be explained.

In the fourth embodiment, an example of assigning the function being assigned to a plurality of the devices (boards) will be explained in addition to the third embodiment. Specifically, an operation will be explained of the case of, in assigning the failure recovery function to the board management unit 3a of the board 5a that is managed by the shelf management unit 2a, selecting the board 5e within the different shelf as one partner of a pair for performing the survival confirmation and the redundancy switchover, and assigning the right to the board management unit 3e as well of the board 5e.

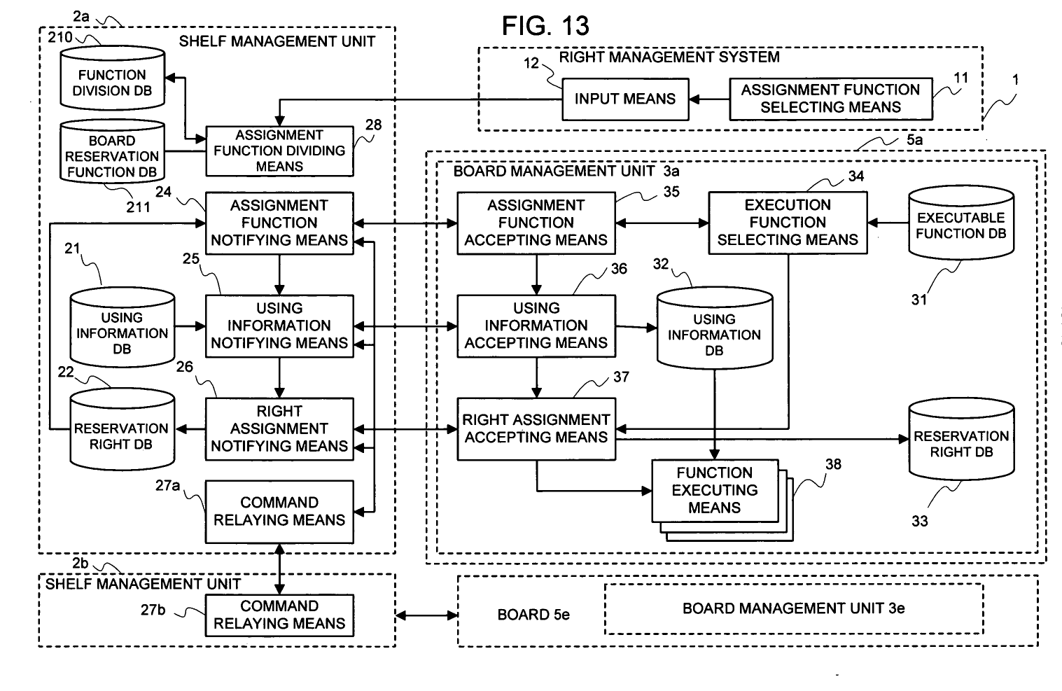

A configuration of the fourth embodiment of the present invention will be explained by making a reference to FIG. 13. The fourth embodiment shown in FIG. 13 differs from the third embodiment in a point that the shelf management unit 2a includes a function division information DB 210, a board reservation function DB 211, and assignment function dividing means 28 in addition the configuration of the shelf management unit of the third embodiment shown in FIG. 9. The means and the database other than these are identical to that of the third embodiment, so its explanation is omitted herein. Additionally, the board management unit 3e, which has the means and the database identical to that of the board management unit 3a, is identical to the board management unit 3a, so the detailed description in FIG. 13 is omitted.

In the function division information DB 210 is stored information as to which type of function the dividable function is divided into.

In board reservation function DB 211 is stored the executable functions that are reserved by each board. This board reservation function DB 211 can be also prepared based upon a kind of the board that is acquired in the automatic configuration discovery.

The assignment function dividing means 28 divides the function, which is specified with identification information such as a name that is input from the input means 12, into the functions on a plurality of the boards. The assignment function dividing means 28 divides the function that is to be assigned into a plurality of the functions based upon the function division information DB 210. Further, the assignment function dividing means 28 decides which board the divided functions are assigned to, based upon the board reservation function DB 211.

Next, an operation of the fourth embodiment of the present invention will be explained.

The case that the shelf management unit 2a divides the failure recovery function in terms of the function, and assigns them to the board management unit 3a and the board management unit 3e, respectively, is exemplified for explanation.

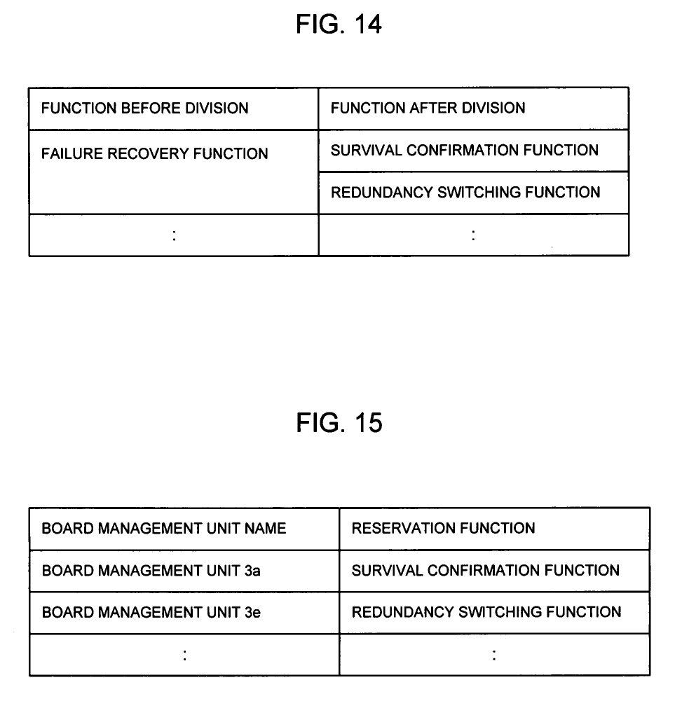

At first, in the shelf management unit 2a, the assignment function dividing means 28 receives a notification saying that the function being assigned is the failure recovery function from the right management system 1. The assignment function dividing means 28 makes a reference to the function division information DB 210 as shown in FIG. 14, and divides the failure recovery function into the survival confirmation function and the redundancy switching function. Further, the assignment function dividing means 28 makes a reference to the board reservation function DB 211 as shown in FIG. 15, and decides that, out of the board management units having the survival confirmation function, the board management unit 3a is an assignee, and that, out of the board management units having the redundancy switching function, the board management unit 3e is an assignee. As a method of selecting the board management unit in the case that a plurality of the board management units have an identical function, there exist the method of selecting the board management unit of which the load is smaller, or the like.

An operation that the assignment function notifying means 24 of the shelf management unit 2a assigns the right to the board management unit 3a is identical to the operation that the assignment function notifying means 24 of the shelf management unit 2a assigns the right to the board management unit 3a in the first embodiment, so the detailed explanation thereof is omitted.

An operation that the assignment function notifying means 24 of the shelf management unit 2a assigns the right to the board management unit 3e is identical to the operation that the assignment function notifying means 24 of the shelf management unit 2a assigns the right to the board management unit 3e in the third embodiment, so the detailed explanation thereof is omitted.

As mentioned above, the assignment function dividing means 28 divides the function being assigned, thereby making it possible to divide one function of an assignor into a plurality of functions, to assign them to a plurality of assignees, and to distribute the load. Herein, an example of the configuration including the command relaying means 27 was explained; however the command relaying means 27 can be omitted with an assignment of the right within the identical shelf.

Next, the fifth embodiment of the present invention will be explained.

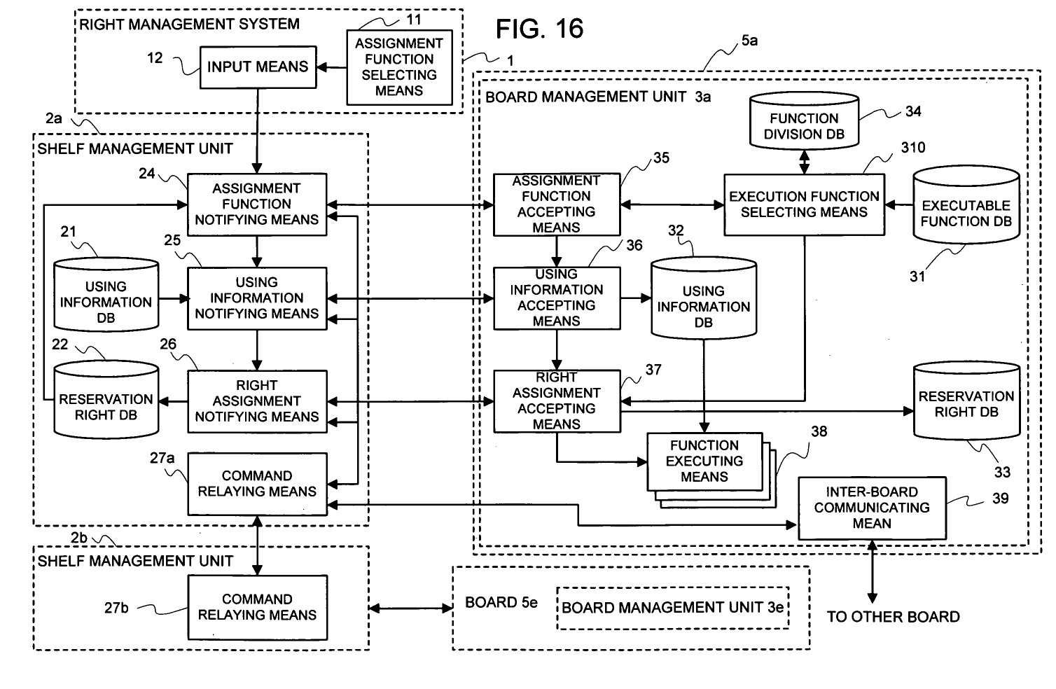

A configuration of the fifth embodiment of the present invention will be explained by making a reference to FIG. 16. The fifth embodiment shown in FIG. 16 differs from the third embodiment in a point that the board management unit 3a includes a function division information DB 310 and inter-board communicating means 39 in addition the configuration of the shelf management unit of the third embodiment shown in FIG. 9. The means and database other than these are identical to that of the third embodiment, so its explanation is omitted herein. Further, the board management unit 3e also has a configuration similar to the foregoing configuration, so the detailed description in FIG. 16 is omitted.

In the function division information DB 310 are stored the function division information DB 210 in the fourth embodiment and information as to which type of function the dividable function is divided into.

The inter-board communicating means 39 directly can exchange information between the different boards without causing information to go through the shelf management unit. Further, causing information to go through the command relaying means 27 also enables an information exchange between the boards each of which exists in a different shelf.

Next, an operation of the fifth embodiment of the present invention will be explained.

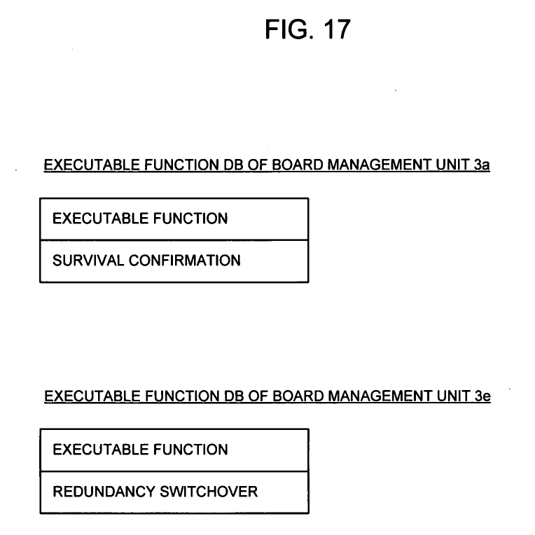

The case that the shelf management unit 2a assigns the failure recovery function to the board management unit 3a is exemplified for explanation. A basic operation is similar to that of the first embodiment shown in FIG. 6, so a reference to the flowchart of FIG. 6 is made for explanation. At this time, as shown in FIG. 17, it is assumed that the executable function DB 31 of the board management unit 3a has the survival confirmation function registered, and the executable function DB 31 of the board management unit 3e has the redundancy switching function registered.

In the step S402, the execution function selecting means 34 makes a reference to the function division information DB 310, and acquires information saying that the failure recovery function acquired as a function being assigned can be divided into the survival confirmation function and the redundancy switching function. Next, the execution function selecting means 34 makes a reference to the executable function DB 31 as shown in FIG. 17, decides to accept an assignment of the survival confirmation function, and assigns the redundancy switching function that is lacking to the board management unit 3e. As a method of deciding that the assignee of the redundancy switching function is the board management unit 3e, there exist the method in which each board includes the board reservation function DB 211 having the function stored that is reserved by each board, and makes a reference hereto, and the method of multicasting a right assignment request to each board to select the board having responded hereto.

In assigning the redundancy switching function to the board 5e, the inter-board communicating means 39 is employed. Information is exchanged via the command relaying means 27a and 27b because each of the board 5a and the board 5e exists in the different shelf.

Upon receipt of an assignment request of the redundancy switching function, the board management unit 3e performs the operation of the step S401 and thereafter of FIG. 6. The shelf management unit 2a performs the operation identical to that of the step S304 and thereafter, and the board management unit 3a performs the operation identical to that of the step S405 and thereafter.

As mentioned above, the execution function selecting means 34 divides the assigned function, thereby making it possible to divide one function of the assignor into a plurality of functions, to assign them to a plurality of the assignees, and to distribute the load.

Herein, an example of the configuration including the command relaying means 27 was explained; however the command relaying means 27 can be omitted with an assignment of the right within the identical shelf.

Further, it is also possible that the board management unit 3a does not notify a request for the redundancy switching function, being a function that is lacking, directly to the board 5e, but notifies it via the shelf management unit 2a. In this case, the shelf management unit 2a receives a notification saying the effect that the redundancy switching function is lacking from the board 5a. Next, the shelf management unit 2a notifies to the board 5e the effect that the assignment function notifying means 24 assigns the redundancy switching function according to the flowchart shown in FIG. 6. The operation after it is identical to the operation of the right assignment spanning the shelves in the third embodiment, so the explanation herein is omitted. In such a manner, making a request for the function that is lacking after dividing the function via the shelf management unit also enables the inter-board communicating means 39 to be omitted.

Above, the embodiments of the present invention were explained by exemplifying the shelf and the board; however an applicable scope of the present invention is not limited to a scope between a shelf and a board, and the system, which is a system in which the centralized process and the distributed process coexist, can obtain the effect of the present invention. For example, there exist a system between a board management unit and a board management system, a system between a shelf management unit and a shelf management unit, there exist a system between a station management unit and a rack management unit or a shelf management unit, a system between a station management unit and a inter-station management unit, and a system between a network management unit for managing an entirety of a network and a station, each of which is a network related system, and there exist a system between a data center entirety management unit for managing an entirety of a data center and a rack or a shelf within a data center, which is a data center related system, or the like.

Further, the boards as well such as a network interface, a switching board, a server board, and a storage board can obtain the effect of the present invention irrespectively of its kind.

Further, the effect of the present invention can be obtained irrespectively of the number of the shelf management unit in a right assignor side, and the number of the board management unit in a right assignee side.

Further, the present invention is applicable not only to a physical device such as the board, but also to a management of an executing right of an application task and a right of an access to data.

The sixth embodiment of the present invention will be explained.

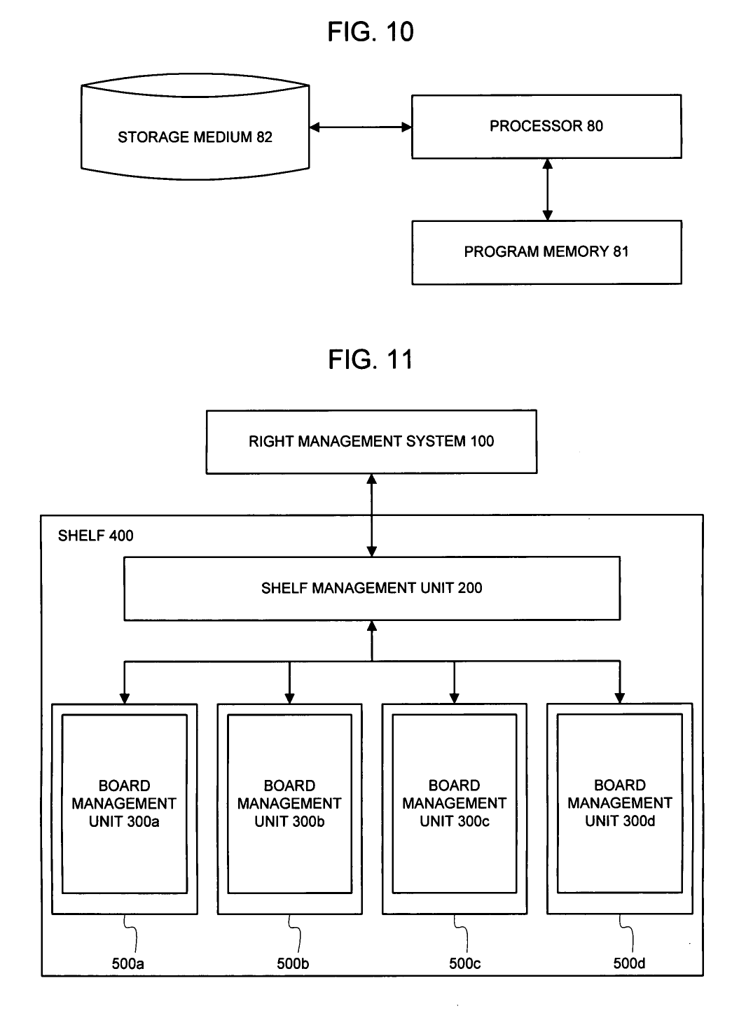

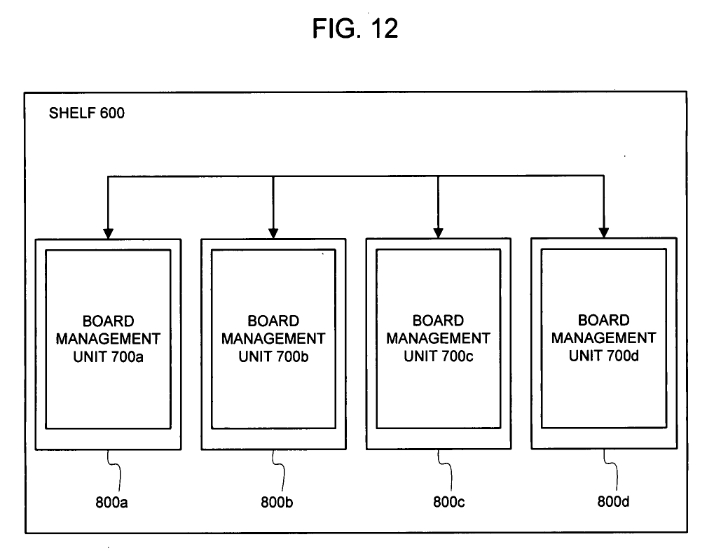

FIG. 10 is a general block diagram of an information processing system having the shelf management unit 2a in accordance with the present invention implemented.

The information processing system shown in FIG. 10 is comprised of a processor 80, a program memory 81, and a storage medium 82. The storage medium 82 may be a separate storage medium, and may be a storage region that is comprised of an identical storage medium. As a storage medium, magnetic storage mediums such as a RAM and a hard disk can be employed.

The program memory 81 has a program filed that causes the processor 80 to perform the processes of the assignment function notifying means 24, the using information notifying means 25, and the right assignment notifying means 26, and the processor 80 operates under this program. The storage medium 82 has the foregoing using information DB 21 and reservation right DB 22 filed. Additionally, likewise, the command relaying means 27b as well may be caused to perform the process with the program.

Likewise, the board management unit 3a as well in accordance with the present invention can be realized with a computer program. In this case, the program memory 81 has a program filed that causes the processor 80 to execute the processes of the foregoing execution function selecting means 34, assignment function accepting means 35, using information accepting means 36, and right assigning accepting means 37, and the processor 80 operates under this program. Further, the storage medium 82 has the foregoing executable function DB 31, using information DB 32, and reservation right DB 33 filed.

Such a configuration enables the operation similar to that of the first embodiment to the fifth embodiment to be obtained.

Additionally, with transmission/reception of data necessary for executing the function, it is also acceptable that some amount of data is transmitted together with the identification information for identifying the function, and data of a difference with the already transmitted data is transmitted after it has been determined that the function is realizable.

1-30. (canceled)

31. A management system for managing an executing right of functions of a first device and a second device, said first device and said second being connected by means of a communication path enabling an exchange of information, characterized in that:
said first device, manages said second device, comprises the means for:
notifying to the second device the function of the executing right that should be assigned from the first device;
notifying data necessary for executing the function of said executing right to said second device; and
in response to a notification about assignability of said executing right from said second device, notifying that said executing right is assigned to said second device; and
said second device comprises the means for:
receiving a notification about the function of the executing right being assigned from said first device;
determining whether the function of said notified executing right is executable by combining the functions that can be executed within the second device, or is substitutable with the function that can be executed within the second device, and if it is determined that it is impossible, notifying unassignability to said first device;
receiving data necessary for executing the function of said executing right from said first device, and determining whether the received data is data satisfactory for executing the function of said executing right;
in a case where the function of said notified executing right is executable, and yet said received data is data satisfactory for executing the function of said executing right, notifying assignability of said executing right to the said first device; and
accepting the executing right of said function from said first device.

32. The management system according to claim 31, characterized in that said first device comprises means for dividing the function of the executing right that should be assigned into the functions that can be executed by a plurality of the second devices, notifying each divided function to a plurality of the second devices, and causing a plurality of the second devices to execute the function of the executing right that should be assigned from the first device.

33. The management system according to claim 31, characterized in that said second device comprises means for, in a case where the function of said notified executing right is unexecutable only with the functions that can be executed within its own device, discovering another second device taking a charge of the function that is lacking, and executing the function of said notified executing right together with said second device.

34. A device for mutually assigning an executing right of a predetermined function between devices, said devices being connected by means of a communication path enabling an exchange of information, characterized in comprising the means for:
notifying to a device being an object of management the function of the executing right that should be assigned;
notifying data necessary for executing the function of said executing right to said another device; and
in response to a notification about assignability of the executing right from said another device, assigning said executing right to said another device.

35. The device according to claim 34, characterized in comprising means for dividing the function of the executing right that should be assigned into the functions that can be executed by a plurality of the devices, notifying each divided function to a plurality of the devices, and causing a plurality of other devices to execute the function of the executing right that should be assigned.

36. A device for mutually assigning an executing right of a predetermined function between devices, said devices being connected by means of a communication path enabling an exchange of information, characterized in comprising the means for:
receiving a notification about the function of the executing right that is assigned from a device being a management entity;
determining whether the function of said notified executing right is executable by combining the functions that can be executed within its own device, or substitutable with the function that can be executed within its own device, and if it is determined that it is impossible, notifying unassignability to the device having notified the function of said executing right;
receiving data necessary for executing the function of said executing right from the device having notified the function of said executing right, and determining whether the received data is data satisfactory for executing the function of said executing right;
in a case where the function of said notified executing right is executable, and yet said received data is data satisfactory for executing the function of said executing right, notifying assignability of said executing right to the device having notified the function of said executing right; and
accepting the executing right of said function from the device having notified the function of said executing right.

37. The device according to claim 36, characterized in comprising means for, in a case where the function of said notified executing right is unexecutable only with the function that can be executed within its own device, discovering another device taking a charge of the function that is lacking, and executing the function of said notified executing right together with said another device.

38. A management method of an executing right of a function between each of a plurality of devices and the other, said plurality of said devices being connected by means of a communication path enabling an exchange of information, characterized in:
by the device being a management entity from which the executing right should be assigned, notifying the function of the executing right that should be assigned, and data necessary for executing this function to a device being an object of management; and
causing the device having received the notification to determine whether the function of said notified executing right is executable by combining the functions that can be executed within the device, or substitutable with the function that can be executed within the device, and in a case where the function of said notified executing right is executable, and yet data necessary for executing the function of said executing right is reservable, assigning the executing right of the function to its device.

39. The management method according to claim 38, characterized in, in a case where the function of the executing right that should be assigned is unexecutable only with one device, dividing the function of said executing right that should be assigned into a plurality of the executable functions, and causing a plurality of the devices to execute each divided function.

40. A program of a device for mutually assigning an executing right of a predetermined function between devices, said devices being connected by means of a communication path enabling an exchange of information, characterized in causing said device to function as the means for:
notifying to a device being an object of management the function of the executing right that should be assigned;
notifying data necessary for executing the function of said executing right to another device; and
in response to a notification about assignability of the executing right from said another device, assigning said executing right to said another device.

41. The program of a device according to claim 40, characterized in causing said device to function as means for dividing the function of the executing right that should be assigned into the functions that can be executed by a plurality of the devices, notifying each divided function to a plurality of the devices, and causing a plurality of other devices to execute the function of the executing right that should be assigned.

42. A program of a device for mutually assigning an executing right of a predetermined function between devices, said devices being connected by means of a communication path enabling an exchange of information, characterized in causing said device to function as the means for:
receiving a notification about the function of the executing right being assigned from a device being a management entity;
determining whether the function of said notified executing right is executable by combining the functions that can be executed within its own device, or substitutable with the function that can be executed within its own device, and if it is determined that it is impossible, notifying unassignability to the device having notified the function of said executing right;
receiving data necessary for executing the function of said executing right from the device having notified the function of said executing right, and determining whether the received data is data satisfactory for executing the function of said executing right;
in a case where the function of said notified executing right is executable, and yet said received data is data satisfactory for executing the function of said executing right, notifying assignability of the said executing right to the device having notified the function of said executing right; and
accepting the executing right of said function from the device having notified the function of said executing right.

43. The program of a device according to claim 42, characterized in causing said device to function as means for, in a case where the function of said notified executing right is unexecutable only with the function that can be executed within its own device, discovering another device taking a charge of the function that is lacking, and executing the function of the said notified executing right together with said another device.

44. A management system of an executing right of a function, characterized in comprising the means for:
notifying the function of the executing right that should be assigned to a device being an object of management;
determining whether the function of said notified executing right is executable by combining the functions that can be executed in a notifyee side, or substitutable with the executable function, notifying assignability of said executing right in a case where the function of said notified executing right is executable, and notifying unassignability in a case where it is unexecutable to a device being a management entity;
in response to a notification about assignability of said executing right, notifying an assignment of said executing right to said device being an object of management; and
accepting an assignment of the executing right of said function.

45. A management system of an executing right of a function between each of a plurality of devices and the other, said plurality of said devices being connected by means of a communication path enabling an exchange of information, characterized in comprising the means for:
notifying the function of the executing right that should be assigned from a device being a management entity to a device being an object of management;
determining whether the function of said notified executing right is executable by combining the functions that can be executed within the device, or substitutable with the function that can be executed within the device, notifying assignability of said executing right in a case where the function of said notified executing right is executable, and notifying unassignability in a case where it is unexecutable to said device being a management entity;
in response to a notification about assignability of said executing right, notifying an assignment of said executing right to said device being an object of management; and
accepting an assignment of the executing right of said function.

46. The management system according to claim 45, characterized in comprising means for, in a case where the function of the executing right that should be assigned is unexecutable only with one device, dividing the function of said executing right that should be assigned into a plurality of the executable functions, and causing a plurality of the devices to execute each divided function.

47. A management method of an executing right of a function, characterized in: notifying the function of the executing right that should be assigned from a device being a management entity to a device being an object of management; determining in a notifyee side whether the function of said notified executing right that is executable by combining the executable functions, or is substitutable with the executable function; and in a case where the function of said notified executing right is executable, assigning the executing right of the function from said device being a management entity to its device.

48. A management method of an executing right of a function between each of a plurality of devices and the other, said plurality of said devices being connected by means of a communication path enabling an exchange of information, characterized in:
by a device being a management entity from which the executing right should be assigned, notifying to a device being an object of management the function of the executing right that should be assigned;
determining in the device having received the notification whether the function of said notified executing right is executable by combining the functions that can be executed within the device, or substitutable with the function that can be executed within the device, and in a case where the function of said notified executing right is executable, assigning the executing right of the function from said device being a management entity to its device.

49. A device for mutually assigning an executing right of a predetermined function between devices, said devices being connected by means of a communication path enabling an exchange of information, characterized in comprising the means for:
by a device being a management entity from which the executing right should be assigned, notifying to a device being an object of management the function of the executing right that should be assigned; and
in response to a notification about assignability of the executing right from said device being an object of management, assigning said executing right to said device being an object of management.

50. A device for mutually assigning an executing right of a predetermined function between devices, said devices being connected by means of a communication path enabling an exchange of information, characterized in comprising the means for:
from a device being an object of management, which the executing right should be assigned, receiving a notification about the function of the executing right being assigned;
determining whether the function of said notified executing right is executable by combining the functions that can be executed within its own device, or substitutable with the function that can be executed within its own device, in a case where the function of said notified executing right is executable, notifying assignability of said executing right to the device having notified the function of said executing right, and in a case where it is unexecutable, notifying unassignability of said executing right to the device having notified the function of said executing right to said device being a management entity; and
accepting the executing right of said function from said device being a management entity, having notified the function of said executing right.

51. A management system for managing an executing right of functions of a first device and a second device, said first device and said second device being connected by means of a communication path enabling an exchange of information, characterized in that:
said first device comprises the means for:
notifying to the second device the function of the executing right that should be assigned from the first device;
notifying data necessary for executing the function of said executing right to said second device; and
in response to a notification about assignability of said executing right from said second device, notifying that said executing right is assigned to said second device; and
said second device, being a device for managing the first device, comprises the means for:
receiving a notification about the function of the executing right being assigned from said first device;
determining whether the function of said notified executing right is executable by combining the functions that can be executed within the second device, or is substitutable with the function that can be executed within the second device, and if it is determined that it is impossible, notifying unassignability to said first device;
receiving data necessary for executing the function of said executing right from said first device, and determining whether the received data is data satisfactory for executing the function of said executing right;
in a case where the function of said notified executing right is executable, and yet said received data is data satisfactory for executing the function of said executing right, notifying assignability of said executing right to the said first device; and
accepting the executing right of said function from said first device.

52. The management system according to claim 51, characterized in that said first device comprises means for dividing the function of the executing right that should be assigned into the functions that can be executed by a plurality of the second devices, notifying each divided function to a plurality of the second devices, and causing a plurality of the second devices to execute the function of the executing right that should be assigned from the first device.

53. The management system according to claim 51, characterized in that said second device comprises means for, in a case where the function of said notified executing right is unexecutable only with the functions that can be executed within its own device, discovering another second device taking a charge of the function that is lacking, and executing the function of said notified executing right together with said second device.

54. A device for mutually assigning an executing right of a predetermined function between devices, said devices being connected by means of a communication path enabling an exchange of information, characterized in comprising the means for:
notifying to a device, being a management entity, the function of the executing right that should be assigned;
notifying data necessary for executing the function of said executing right to another device; and
in response to a notification about assignability of the executing right from said another device, assigning said executing right to said another device.

55. The device according to claim 54, characterized in comprising means for dividing the function of the executing right that should be assigned into the functions that can be executed by a plurality of the devices, notifying each divided function to a plurality of the devices, and causing a plurality of other devices to execute the function of the executing right that should be assigned.

56. A device for mutually assigning an executing right of a predetermined function between devices, said devices being connected by means of a communication path enabling an exchange of information, characterized in comprising the means for:
receiving a notification about the function of the executing right that is assigned from a device, being an object of management;
determining whether the function of said notified executing right is executable by combining the functions that can be executed within its own device, or substitutable with the function that can be executed within its own device, and if it is determined that it is impossible, notifying unassignability to the device having notified the function of said executing right;
receiving data necessary for executing the function of said executing right from the device having notified the function of said executing right, and determining whether the received data is data satisfactory for executing the function of said executing right;
in a case where the function of said notified executing right is executable, and yet said received data is data satisfactory for executing the function of said executing right, notifying assignability of said executing right to the device having notified the function of said executing right; and
accepting the executing right of said function from the device having notified the function of said executing right.

57. The device according to claim 56, characterized in comprising means for, in a case where the function of said notified executing right is unexecutable only with the function that can be executed within its own device, discovering another device taking a charge of the function that is lacking, and executing the function of said notified executing right together with said another device.

58. A management method of an executing right of a function between each of a plurality of devices and the other, said plurality of said devices being connected by means of a communication path enabling an exchange of information, characterized in:
by a device, being an object of management, from which the executing right should be assigned, notifying the function of the executing right that should be assigned, and data necessary for executing this function to a device, being a management entity; and
causing the device having received the notification to determine whether the function of said notified executing right is executable by combining the functions that can be executed within the device, or substitutable with the function that can be executed within the device, and in a case where the function of said notified executing right is executable, and yet data necessary for executing the function of said executing right is reservable, assigning the executing right of the function to its device.

59. The management method according to claim 58, characterized in, in a case where the function of the executing right that should be assigned is unexecutable only with one device, dividing the function of said executing right that should be assigned into a plurality of the executable functions, and causing a plurality of the devices to execute each divided function.

60. The management system according to claim 32, characterized in that said second device comprises means for, in a case where the function of said notified executing right is unexecutable only with the functions that can be executed within its own device, discovering another second device taking a charge of the function that is lacking, and executing the function of said notified executing right together with said second device.

61. The management system according to claim 52, characterized in that said second device comprises means for, in a case where the function of said notified executing right is unexecutable only with the functions that can be executed within its own device, discovering another second device taking a charge of the function that is lacking, and executing the function of said notified executing right together with said second device.
